(19) United States
(12) Patent Application Publication
(10) Pub. No.: US 2014/0295381 A1
(43) Pub. Date: Oct. 2, 2014

(54) RETIREMENT PLANNING GAME

(71) Applicant: TATA CONSULTANCY SERVICES LIMITED, Mumbai (IN)

(72) Inventors: Suresh Bhaskaramurthy, Chennai (IN); A.K. Suresh, Chennai (IN); Praveen Kumar Talagadadeevi, Chennai (IN)

(73) Assignee: Tata Consultancy Services Limited, Mumbai (IN)

(21) Appl. No.: 13/851,066

(22) Filed: Mar. 26, 2013

(51) Int. Cl. G09B 19/18

(52) U.S. Cl. CPC G09B 19/18; G06Q 40/06
USPC 434/109

(57) ABSTRACT

Disclosed is method and system for educating at least one player about financial planning through a financial planning game. In one implementation, to start the game, the player inputs player-associated data, based upon a plurality of life-stages and scenario for each life-stage to be configured. The scenario further comprises incomes and expenses. At first life-stage, the player is prompted for investing disposable income in financial fund, where the disposable income is an amount left after deducting the expenses from the incomes. After investing the disposable income, the player is navigated through each life-stage and corresponding scenario presented to the player for which the player-response data is captured. The player-response data represents the player's strategy in deciding on the incomes to be spent over the expenses and the disposable income invested in the financial fund. Based on the player-response data, financial information is generated providing growth information pertaining to the financial fund.

### TECHNICAL FIELD

The present subject matter described herein, in general, relates to a method and a system for financial planning

### BACKGROUND

Financial planning is an important aspect in everyone's life. Every person has financial objectives and they plan to achieve their financial objectives accordingly. Specially, when it comes to retirement planning, the people who are salaried, non-salaried, business running individuals and other individuals should plan their retirement life in a proper manner. Different stages come in one's life, and every stage has its own financial demand as well as limitation. From the different stages of life, the retirement life is one of a most important life stage where the person wants to be financially secured with a sufficient financial support. Moreover, there are uncertainties and risk in everyone's life. So, to overcome these financial dependency and the uncertainties in the life, a sensible and proper financial planning is required.

Thus, to make a sensible financial planning lots of financial planning skills are required. Understanding the financial skills is not an easy job for every individual. Although, there are number of financial planning tools available in the market, they are not interactive, intuitive and user-engaging in nature. Apart from being non-interactive, the available financial planning tools are also difficult to understand. The person who desires to use these available tools is expected to be a skilled person having a fair knowledge of financial skills. For using such available tools, the person is also required to enter different values in the numerous data fields which make the process hectic as well as confusing too. Also, lot of time is spent in understanding the usability of these available financial planning tools.

### SUMMARY

This summary is provided to introduce aspects related to systems and methods for educating a player about a financial planning through a financial planning game and the concepts are further described below in the detailed description. This summary is not intended to identify essential features of the claimed subject matter nor is it intended for use in determining or limiting the scope of the claimed subject matter.

In one implementation, a system for educating at least one player about a financial planning through a financial planning game is disclosed. The system comprises a processor and a memory coupled to the processor for executing a set of modules stored in the memory. The set of modules comprises a receiving module, a configuring module, a prompting module, a navigation module, a display module and a financial information generation module. The receiving module may be configured to receive player-associated data as input from the at least one player. The configuring module may be configured to configure plurality of life stages based upon the player-associated data. From the plurality of life stages, at least one life stage is associated with the at least one player. Further, the configuring module is also configured to configure at least one scenario associated with each life stage. The at least one scenario configured by the configuring module further comprises at least one income and appropriate expenses. Upon configuring the plurality of life-stages and the at least one scenario for each life stage, the prompting module may be configured to prompt the at least one player for investing disposable income at a first life-stage of the plurality of the life stages for proceeding with the financial planning game. The disposable income is an amount left after deducting the appropriate expenses from the at least one income. Thereafter, the navigation module may be configured to navigate each life stage of the plurality of life stages to the at least one player and the navigating commences after the first life stage. Further, the display module may be configured to present the scenario associated with the life stage being navigated in order to capture player-response data for the life-stage being navigated. The player-response data represents player's strategy in playing the financial planning game. Also, the player response data exemplifies a decision made by the at least one player to decide an amount to be spent on the appropriate expenses from the at least one income and to further decide on how to invest the disposable income in a financial fund.

In another implementation, a method for educating at least one player about financial planning through a financial planning game is disclosed. The method comprises multiple steps performed by a processor, one of a step is for receiving player-associated data as input from the at least one player. After receiving the player-associated data, a step of configuring plurality of life stages based upon the player-associated data is performed. From the plurality of life stages, at least one life stage is associated with the at least one player. Furthermore, a step is also performed for configuring at least one scenario associated with each life stage. The at least one scenario comprises at least one income and appropriate expenses. After configuring the plurality of life stages and the at least one scenario, a step is performed for prompting the at least one player to invest disposable income at a first life-stage of the plurality of the life stages to proceed with the financial planning game. The disposable income is an amount left after deducting the appropriate expenses from the at least one income. Thereafter, a step is performed for navigating each life stage of the plurality of life stages to the at least one player, wherein the navigating commences after the first life stage. While navigating through each life stage, a step is performed to present the scenario associated with the life stage being navigated in order to capture player-response data for the life stage being navigated. The player-response data that is captured represents player's strategy in playing the financial planning game. Further, the player response data exemplifies a decision made by the at least one player to decide an amount to be spent on the appropriate expenses from the at least one income and to further decide on how to invest the disposable income in a financial fund. Thus, after capturing the player-response data, a step is performed for generating financial information for the at least one player at each life stage of the plurality of life stages based upon the player-response data for providing growth information pertaining to the financial fund.

In yet another implementation, a non-transitory computer program product having embodied thereon a computer program for educating at least one player about financial planning through a financial planning game is disclosed. The computer program product comprises a program code for receiving player-associated data as input from the at least one player. Upon receiving the player-associated data, a program code is provided for configuring plurality of life stages based upon the player-associated data. From the plurality of life stages, at least one life stage is associated with the at least one player. The program code which is provided for configuring plurality of life stages is further provided for configuring at least one scenario associated with each life stage, wherein the at least one scenario comprises at least one income and appropriate expenses. After configuring the plurality of life stages and the at least one scenario associated with each life stage, a program code is provided for prompting to the at least one player for investing disposable income at a first life-stage of the plurality of the life stages to proceed with the financial planning game. The disposable income is an amount left after deducting the appropriate expenses from the at least one income. Thereafter, a program code is further provided for navigating each life stage of the plurality of life stages to the at least one player, wherein the navigating commences after the first life stage. While navigating through each life stage, a program code is provided for presenting the scenario associated with the life stage being navigated in order to capture player-response data for the life stage being navigated. The player-response data which is captured represents player's strategy in playing the financial planning game. Further, the player response data exemplifies a decision made by the at least one player to decide an amount to be spent on the appropriate expenses from the at least one income and further decide on how to invest the disposable income in a financial fund. Further, program code is also provided for generating financial information for the at least one player at each life stage of the plurality of life stages based upon the player-response data for providing growth information pertaining to the financial fund.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to refer like features and components.

FIG. 1 illustrates a network implementation of a system for educating at least one player about financial planning through a financial planning game is shown, in accordance with an embodiment of the present subject matter.

FIG. 2 illustrates the system, in accordance with an embodiment of the present subject matter.

FIG. 3 illustrates a method for educating the at least one player about the financial planning through the financial planning game, in accordance with an embodiment of the present subject matter.

### DETAILED DESCRIPTION

Systems and methods for educating at least one player about financial planning through a financial planning game have been disclosed. The “financial planning game” hereinafter referred as “game” may be an interactively engaging game that engages and educates the “at least one player” hereinafter referred as “player” about different aspects of financial planning. The financial planning may be about one of: retirement planning, investment planning, administering loan premium repayments and allocating financial assets. The player may be a retiree, an investor, a borrower or any other person playing the game. Further, the game may be configured to be played for any one of the financial planning discussed above i.e., for the retirement planning, for the investment planning, for administering loan premium repayments and for allocating financial assets.

To start the game, the player may input player-associated data. The player-associated data may represent the player's basic information required by the game for performing various calculations. The player-associated data may comprise details of the player such as player's current age, annual income, planned retirement age, current bank balance, existing retirement balance and type of life-style followed by the player.

Based on the player-associated data and the life-style followed by the player, the game may configure plurality of life-stages and at least one scenario for each life-stage of the player. The at least one scenario may further comprise at least one income and appropriate expenses. The at least one income and appropriate expenses may be presented to each life-stage of the player.

Player may start the game from a first life-stage of the plurality of life-stages. At the first life-stage, the player may be prompted to invest disposable income to proceed with the game. The disposable income may be an amount left after deducting the appropriate expenses from the at least one income. The disposable income may be invested in a financial fund.

Upon investing the disposable income at the first life-stage, the player may be navigated through each life-stage of the plurality of life-stages, wherein the navigation commences, for example, from the first-life stage of the player. While the player navigates through each life-stage, the scenario associated with each life-stage may be presented to the player in order to capture player-response data. As discussed above, the scenario may comprise the at least one income and the appropriate expenses configured for each life-stage of the player. The player-response data that is captured may exemplify the player's decision made on an amount from the at least one income to be spent over the appropriate expenses. Further, the player-response data may also include the player's decision in investing the disposable income in the financial fund. The player-response data captured while playing the game may show the player's strategy for financial planning. Based on the player-response data captured for each life-stage, financial information may be generated for the player. The financial information may provide growth information of the financial fund i.e., the amount accumulated in the financial fund based on the investment made by the player while playing the game. Thus, the game may provide a platform for the player to get educated about different aspects of the financial planning.

While aspects of described system and method for educating the player about the financial planning through the game i.e., the financial planning game may be implemented in any number of different computing systems, environments, and/or configurations, the embodiments are described in the context of the following exemplary system.

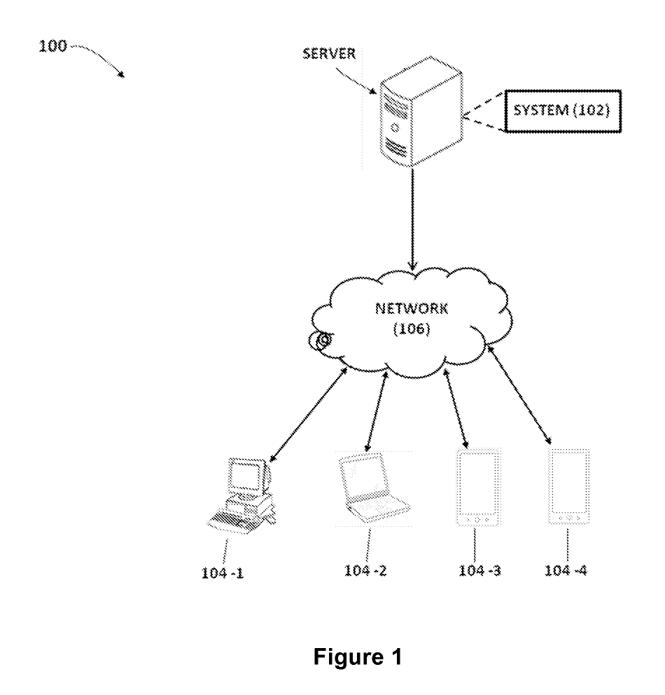

Referring now to FIG. 1, a network implementation 100 of system 102 for educating the player about the financial planning is illustrated, in accordance with an embodiment of the present subject matter. In one embodiment, the system 102 is facilitated for educating the player about the financial planning through the game.

Although the present subject matter is explained considering that the system 102 is implemented for the player to play the game on a server, it is to be understood that the system 102 may also be implemented in a variety of computing systems, such as a laptop computer, a desktop computer, a notebook, a workstation, a play-station, a mainframe computer, a server, a network server, and the like. It will be understood that the system 102 may be accessed by multiple users or players through one or more user devices 104-1, 104-2 . . . 104-N, collectively referred to as user or the player 104 hereinafter, or applications residing on the user devices 104. Examples of the user devices 104 may include, but are not limited to, a portable computer, a personal digital assistant, a handheld device, and a workstation. The user devices 104 may be communicatively coupled to the system 102 through a network 106.

In one implementation, the network 106 may be a wireless network, a wired network or a combination thereof. The network 106 can be implemented as one of the different types of networks, such as intranet, local area network (LAN), wide area network (WAN), the internet, and the like. The network 106 may either be a dedicated network or a shared network. The shared network may represent an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

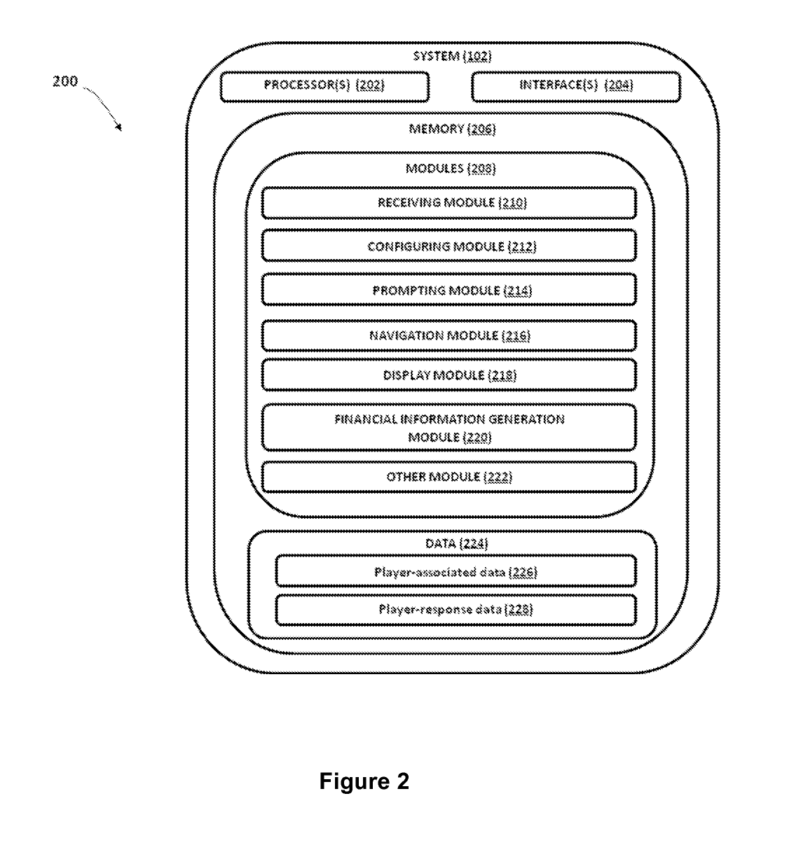

Referring now to FIG. 2, the system 102 is illustrated in accordance with an embodiment of the present subject matter. In one embodiment, the system 102 may include at least one processor 202, an input/output (I/O) interface 204, and a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 may be configured to fetch and execute computer-readable instructions or modules stored in the memory 206.

The I/O interface 204 may include a variety of software and hardware interfaces, for example, a web interface, a graphical user interface, and the like. The I/O interface 204 may allow the system 102 to interact with a user or player directly or through the client devices 104. Further, the I/O interface 204 may enable the system 102 to communicate with other computing devices, such as web servers and external data servers (not shown). The I/O interface 204 can facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium or computer program product known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, a compact disks (CDs), digital versatile disc or digital video disc (DVDs) and magnetic tapes. The memory 206 may include modules 208 and data 224.

The modules 208 may include routines, programs, objects, components, data structures, etc., which perform particular tasks or implement particular abstract data types. In one implementation, the modules 208 may include a receiving module 210, a configuring module 212, a prompting module 214, a navigation module 216, a display module 218, a financial information generation module 220 and other modules 222. The other modules 222 may include programs or coded instructions that supplement applications and functions of the system 102.

The data 224, amongst other things, serves as a repository for storing data processed, received, and generated by one or more of the modules 208. The data 224 may also include player-associated data 226 and player-response data 228, both stored in database (not shown in the figure) of the memory 206.

In accordance with an embodiment of the present subject matter, the receiving module 210 may be configured to receive player-associated data 226 entered by the player. To start the game the player may enter player-associated data 226, which may be stored in the database of the system 102. The player-associated data 226 may comprise details pertaining to current age, annual income, planned retirement age, current bank balance, existing retirement balance and life-style of the player. There may be different types of the life-style such as “modest”, “comfortable”, extravagant, “custom” or any other type of the life-style which may be presented to the player while playing the game. From the different types of the life-style presented to the player, the player may choose one or more type of the life-style to start the game.

According to the type of the life-style chosen along with the details of the player-associated data 226 entered by the player, the configuring module 212 may be configured to configure plurality of life-stages for the player. From the plurality of life-stage, the player may get associated with at least one life-stage. The plurality of life-stages configured for playing the game may be “being single”, “being married”, “being a parent”, and “being in an age range pertaining to nearing retirement. Each life-stage of the plurality of the life-stages may be restricted with a certain age limit of the player.

For example, the age limit of “0-27” may correspond to the life-stage of “being single”. Similarly, the age limit of “28-32”, “33-45” and 46 above may corresponds to the life-stages of “being married”, “being a parent” and “being in an age range pertaining to nearing retirement” respectively. It should be noted that the present disclosure is not limited with the above discussed life-stages and their corresponding age limits. The above-discussed age limits or any other age limits may be defined in any combination with each life-stage of the plurality of stages of the player.

Along with the plurality of life-stages, the configuring module 212 may also be configured to configure one or more scenarios associated with each life stage of the player. The “at least one scenario” hereinafter referred as “scenario” further may comprise at least one income and appropriate expenses. The at least one income hereinafter referred as “income” may further comprise sources of income, wherein the sources of income may differ from one life-stage to another life-stage. Similarly, the appropriate expenses may further comprise of sources of appropriate expenses, wherein the sources of appropriate expenses may also differ from the one life-stage to another life-stage. The incomes and appropriate expenses may be presented to the at least one player as multiple surprising and/or mystery elements in an animated form while playing the game. In an exemplary embodiment, the surprising and/or mystery elements may be scenario specific and may be automatically popped-up on a game interface depending on the context of the life-stage, the player is navigating through. For example, in the married stage, the surprising element/mystery element in form of “Investing in Reality Sector” can be displayed, wherein the reality picture in animated form can be displayed. Further, the option of “buying a home loan” through various financial institution with varied interest rates can be displayed as another surprising element. Similarly, considering the scenario where the player is in the life-stage of “being single”, the sources of incomes presented to the player while playing the game in form of the mystery/surprising elements may be “increase in annual income”, “bonus amounts”, “investment incomes”, “windfall income” or any other source of income which may be defined for the life-stage of “being single”. For the same scenario considered above, where the player is in the life-stage of “being single”, the sources of appropriate expenses presented to the player while playing the game in form of the other mystery/surprising elements may be “increase in annual expense”, “loan repayments”, “car purchase”, “vacation expense” or any other sources of appropriates expenses which may be defined for the life-stage of “being single”.

### In Some Implementations, the Terms or Definitions Used in the Description May be Defined in an Exemplary Manner as Follows:

“Total Incomes”—The sum of all the sources of income is referred as “Total Incomes”.
“Total Expenses”—The sum of all the sources of appropriate expenses is referred as “Total Expenses”.
“Disposable Income”—Amount left by deducting the “Total Expenses” from the “Total Incomes” after spending from the sources of income over the sources of expenses is referred as “Disposable Income”.
Further the disposable amount may be determined for each life-stage of the plurality of life-stages.

Starting from first life-stage of the plurality of life-stages, the prompting module 214 may be configured to prompt the player to invest the disposable income for proceeding with the game. The disposable income may be invested by the player in a financial fund. The financial fund will be discussed in detail in later part of the description of the disclosure.

After investing the disposable income in the first life-stage, the navigation module 216 may be configured for navigating the player through each life-stage of the plurality of life-stages, wherein the navigation commences from the first-life stage of the player. In an embodiment of the disclosure, the user may navigate through each life-stage by playing through a roulette displayed on the game interface while playing the game. Playing the roulette may help the player to move from one life stage to another life-stage of the plurality of life-stages.

While navigating through each life-stage, the display module 218 may be configured to present the scenario associated with each life-stage to the player. As discussed above, the scenario may comprises the incomes and the appropriate expenses and further, the incomes and appropriate expenses may comprise the “sources of income” and the “sources of appropriate expenses” respectively. For each life-stage being navigated to the player, the game may be configured to capture player-response data 228 stored in the database of the system 102. The player-response data 228 may be captured in at least two separate modes. In the first mode, the player-response data 228 may be captured in response to the player's decision to spend an amount from the sources of income over the sources of appropriate expenses. Here the player may have to wisely decide how much amount has to be spent from the amount available in the different sources of income over the sources of appropriate expenses. In the second mode, the player-response data may be further captured in response to the player's decision to invest the disposable income in the financial fund. The disposable income may be obtained by deducting the “Total Expenses” from the “Total Income” after spending from the source of incomes over the sources of expenses.

In accordance with an embodiment of the present disclosure, the financial fund further may comprise one or more options where the player may invest the disposable income. The one or more options may be “savings”, “stock investment” and “retirement fund”. It should be noted that the financial fund of the present disclosure is not limited to the above-described options and there may be other options also which may be defined for playing the game. Thus, the player-response data 228 captured in the first mode and the second mode collectively may reflect the player's strategy while playing the game. The player's strategy may show the ability of the player to plan over different aspects of the financial planning while playing the game.

Corresponding to the player-response data 228 captured for each life-stage of the plurality of life-stages, the financial information generation module 220 may be configured to generate financial information for the player for each life-stage through which the player is navigated while playing the game. The financial information may provide growth information pertaining to the financial fund. The financial information may comprise a current amount and a future retirement lump sum amount generated for each life-stage of the plurality of life-stages.

In accordance with an embodiment of the present, the player may be provided with an opportunity to re-strategize the financial planning based on the financial information generated.

In accordance with an embodiment of the present disclosure, the game may be configured to generate a score in response to the player-response data 228 for the player. In one embodiment, the score may be calculated based on the player-response data 228 captured for each life stage including the post-retirement stage. More particularly, in an exemplary embodiment, the score calculated in preceding life-stage may be incremented in the subsequent stage based on the payer-response data 228 in the subsequent stage. Therefore, the score that will be displayed finally to the player may indicate an aggregation of the scores gained while navigating through the plurality of life-stages involved in the game. In an exemplary embodiment, the score calculated for each life-stage may analyze the decision made by the player while investing towards the financial fund in the game. Further, in accordance with another embodiment of the present disclosure the score generated for the player can be shared on social community platforms like facebook, twitter or other social community platforms. One player can compete with the other player on the social community platforms on the basis of the score generated. Once the score is generated and shared on the social community platform, the player can also invite the other player to play the game and challenge them to beat the score. Thus, by enabling the game to be played on the social community platforms, the player can share his/her gaming experience with the other players also.

In accordance with another embodiment of the present disclosure, the game may be also enabled for recommending one or more financial products based on the player-associated data 226 received by the player while playing the game. In an exemplary embodiment, the game may be configured to recommend the one or more financial products at each of the life-stages navigated by the player. The financial products recommended to the player may be selected from a group comprising a mutual fund, an insurance policy, financial loan and combination thereof. In one embodiment, the game may analyze the behavior, habits and context of the player through the player-response data 228 to create a profile associated with the player. Based on the profile created, the financial need of the player may be identified and accordingly at least one focused product matching with the financial need of the player may be recommended. The at least one focused product may be specifically displayed to the player at the end of the game. This may enable Insurers and other service providers in financial domain get valuable information in a form of the player-associated data 226, the player-response data 228 and the profile created for the player at each life stage to devise appropriate marketing strategies for targeting the customers.

In accordance with yet another embodiment of the present disclosure, the game may be realized by a “Jack and the Beanstalk Story”. The height of the beanstalk tree in the Jack and the Beanstalk Story may proportionally increase for each life-stage of the player, where the height of the beanstalk tree is proportional to the amount invested in the financial fund. Thus, associating the Jack and the Beanstalk Story with the game, it may help the player to understand staggered growth of the financial fund based on the investment made by the player. It also may help the player to learn about the consequences occurred upon the decision made by the player while spending the incomes over the expenses and the investment done by investing the disposable income in the financial fund. It should be noted that the game may be realized by any other pre-defined story other than the “Jack and the Beanstalk Story” which can be played by the player.

In accordance with yet another embodiment of the present disclosure, the player may be represented as a virtual character while playing game. The virtual character may vary in its appearance based on situation of the player in each life-stage of the game. The virtual character may also change its appearance throughout the game based on the life-stages and the player's decisions made by the player while playing the game. Further, the virtual character may also be enabled for climbing up the beanstalk tree as the player proceeds with the game from the one life-stage to the another life-stage of the player.

In accordance with yet another embodiment of the present disclosure, the game may be played by the player for the retirement planning. Further, the game may be configured to present at least one post-retirement expense to the player. The “at least one post-retirement expense” hereinafter referred as “post-retirement expense” may be presented after the game is played till last life-stage of the plurality of life-stages by the player. The post-retirement expense presented to the player may be purchasing car, purchasing home, planning vacation, investing in annuities, health related expense or any other expenses which may be applicable as the post-retirement expenses. The player may spent amount accumulated in his/her financial fund over the post-retirement expense.

Based on the amount spent over the post-retirement expense by the player, the game may be configured to calculate a remaining-amount for the player. The remaining-amount may be an amount left in the financial fund after the amount i.e., the amount accumulated in the financial fund of the player, is spent over the post-retirement expense by the player. The game may be further configured to calculate a maximum time i.e., the time till the remaining-amount in the financial fund will last or sustain for the player. Further, the maximum time may be compared with an average-life expectancy of the player.

In one implementation, at first, the user or the player may use the client device 104 to access the system 102 via the I/O interface 204. The users or the players may register them using the I/O interface 204 in order to use the system 102. The working of the system 102 is explained above in detail in FIG. 2. The system 102 may be used for educating the player about the financial planning and their various aspects by playing the game. The game i.e., the financial planning game intuitively engages the player to interact with the game.

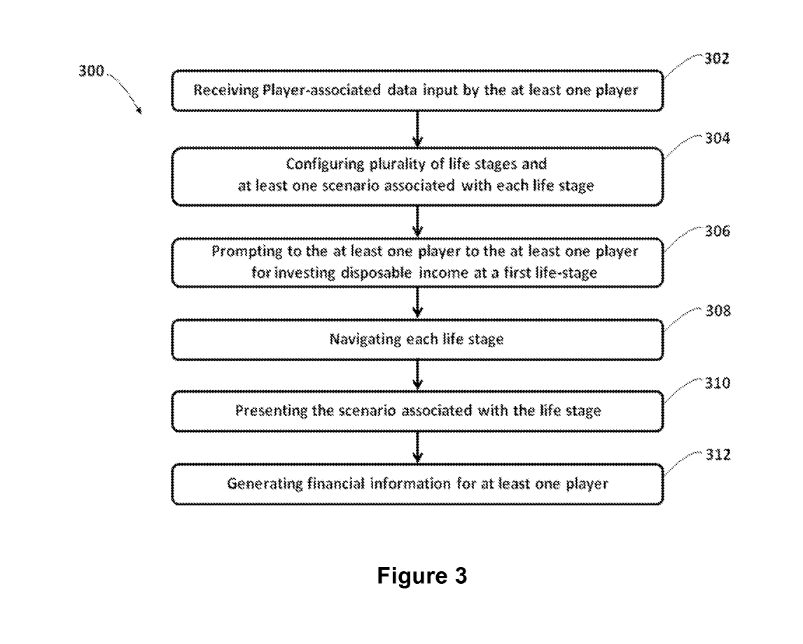

Referring now to FIG. 3, the method for educating at least one player about financial planning through a game financial planning i.e., financial planning game is shown, in accordance with an embodiment of the present subject matter. The method 300 may be described in the general context of computer executable instructions. Generally, computer executable instructions can include routines, programs, objects, components, data structures, procedures, modules, functions, etc., that perform particular functions or implement particular abstract data types. The method 300 may also be practiced in a distributed computing environment where functions are performed by remote processing devices that are linked through a communications network. In a distributed computing environment, computer executable instructions may be located in both local and remote computer storage media, including memory storage devices.

The order in which the method 300 is described is not intended to be construed as a limitation, and any number of the described method blocks can be combined in any order to implement the method 300 or alternate methods. Additionally, individual blocks may be deleted from the method 300 without departing from the spirit and scope of the subject matter described herein. Furthermore, the method can be implemented in any suitable hardware, software, firmware, or combination thereof. However, for ease of explanation, in the embodiments described below, the method 300 may be considered to be implemented in the above described system 102.

At block 302, player-associated data 226 may be received. The player-associated data 226 may be entered by the player in order to start the game. The player-associated data 226 may comprise details pertaining to current age, annual income, planned retirement age, current bank balance, existing retirement balance and life-style. While entering the player-associated data 226 by the player, the different type of life-styles may be presented to the player. The player may select one of the life-style that is followed by him/her from the different life-styles presented.

At block 304, plurality of life stages based upon the player-associated data 226 may be configured. From the plurality of the life-stages configured, at least one life-stage is associated with the player. Along with the plurality of life-stages, at least one scenario associated with each life stage may also be configured for the player. The at least one scenario further may comprise at least one income and appropriate expenses.

At block 306, the player may be prompted for investing disposable income at a first life-stage of the plurality of the life stages for proceeding with the game. The disposable income may be an amount left after deducting the appropriate expenses from the at least one income.

At block 308, the player may be navigated through each life-stage of the plurality of life-stages. The navigation of the player may start from the first life-stage of the player.

At block 310, the at least one scenario associated with each life stage being navigated may be presented to the player. The scenario may be presented in order to capture player-response data 228. The player-response data 228 may be stored in a database of the system 102. The player-response data 228 may represent player's strategy in deciding on an amount from the at least one income to be spent on the appropriate expenses and further deciding on investment of the disposable income in a financial fund.

At block 312, financial information may be generated for each life-stage of the player based on the player-response data 228. The financial information may provide growth information pertaining to the financial fund.

Exemplary embodiments discussed above may provide certain advantages. Though not required to practice aspects of the disclosure, these advantages may include:

1. Providing a gaming approach for educating the player about financial planning.

2. Providing a practical experience to the player by presenting surprising elements in form of incomes and expenses at each life-stage of the player.

3. Providing real-time financial consequences based on the player response made while playing the game to enable the player to learn about financial skills required for financial planning.

Although implementations for methods and systems for educating the player about financial planning have been described in language specific to structural features and/or methods, it is to be understood that the appended claims are not necessarily limited to the specific features or methods described. Rather, the specific features and methods are disclosed as examples of implementations for educating at least one player about financial planning through a financial planning game.

1. A method for educating at least one player about financial planning through a financial planning game, the method comprising:
receiving, by a processor, player-associated data input by the at least one player;
configuring, by the processor:
plurality of life stages based upon the player-associated data, wherein at least one life stage is associated with the at least one player; and
at least one scenario associated with each life stage, wherein the at least one scenario comprises at least one income and appropriate expenses;
prompting, by the processor, to the at least one player for investing disposable income at a first life-stage of the plurality of the life stages for proceeding with the financial planning game, wherein the disposable income is an amount left after deducting the appropriate expenses from the at least one income;
navigating, by the processor, each life stage of the plurality of life stages to the at least one player, wherein the navigating commences after the first life stage;
presenting, by the processor, the scenario associated with the life stage being navigated in order to capture player-response data for the life stage being navigated, wherein:
the player-response data represents player's strategy and wherein the player response data facilitates the at least one player to decide:
an amount from the at least one income to be spent on the appropriate expenses; and
investment of the disposable income in a financial fund; and
generating, by the processor, financial information for at least one player at each life stage of the plurality of life stages based upon the player-response data for providing growth information pertaining to the financial fund.

2. The method of claim 1, wherein the financial planning is about one of a retirement planning, an investment planning, administering loan repayments and allocating financial assets.

3. The method of claim 1, wherein the at least one player is one of a retiree, an investor, a borrower or any other person playing the financial planning game.

4. The method of claim 1, wherein the player-associated data comprises details pertaining to current age, annual income, planned retirement age, current bank balance, existing retirement balance and life-style.

5. The method of claim 1, wherein the plurality of life-stages comprises being single, being married, being a parent, and being in an age range pertaining to nearing retirement.

6. The method of claim 1, wherein the financial information is information pertaining to a current amount and a Future Retirement Lump sum amount generated at each life-stage of the at least one player based on the player-response data.

7. The method of claim 1, wherein the financial planning game is configured to generate a score in response to the player-response data.

8. The method of claim 7, wherein the at least one player can compete with the at least other player on a social community platform on the basis of the score generated based on the player-response data.

9. The method of claim 7, wherein the financial planning game further recommends one or more financial products comprising mutual fund, insurance policy, financial loan to the at least one player based on the score generated.

10. The method of claim 1, wherein the financial planning game is realized by a Jack and the Beanstalk Story, wherein the height of the beanstalk in the Jack and the Beanstalk Story is proportional to the amount invested in the financial fund.

11. The method of claim 1, wherein the at least one player is provided with an opportunity to re-strategize the financial planning based on the financial information generated for the player.

12. The method of claim 1, wherein the at least one player is represented as a virtual character, wherein the virtual character varies in appearance based on situation of the at least one player at each life-stage of the game.

13. The method of claim 1, wherein the financial planning game is configured to present at least one post-retirement expense to the at least one player, wherein the at least one post-retirement expense is presented after the financial planning game is played till last life-stage of the plurality of life-stages by the at least one player.

14. The method of claim 13, wherein the financial planning game is configured to calculate a remaining-amount based on amount spent over the at least one post-retirement expense by the at least one player, wherein the remaining-amount is an amount left in the financial fund after the amount spent over the at least one retirement expense by the at least one player.

15. The method of claim 14, wherein financial planning game is configured to calculate maximum time till the remaining-amount in the financial fund will last for the at least one player, wherein the maximum time is compared with an average-life expectancy of the at least one player.

16. The method of claim 13, wherein the at least one post-retirement expense may be purchasing car, purchasing home, planning vacation, investing in annuities, health related expense or combination thereof.

17. The method of claim 1, wherein the at least one income and appropriate expenses are presented to the at least one player in an animated form.

18. A system for educating at least one player about a financial planning through a financial planning game, the system comprising:
a processor; and
a memory coupled to the processor, the memory comprising a plurality of modules capable of being executed by the processor, wherein the plurality of modules comprises:
a receiving module configured to receive player-associated data input by the at least one player;
a configuring module configured to configure:
plurality of life stages based upon the player-associated data, wherein at least one life stage is associated with the at least one player; and
at least one scenario associated with each life stage, wherein the at least one scenario comprises at least one income and appropriate expenses;
a prompting module configured to prompt the at least one player for investing disposable income at a first life-stage of the plurality of the life stages for proceeding with the financial planning game, wherein the disposable income is an amount left after deducting the appropriate expenses from the at least one income;
a navigation module configured to navigate each life stage of the plurality of life stages to the at least one player, wherein the navigating commences after the first life stage;
a display module configured to present the scenario associated with the life stage being navigated in order to capture player-response data for the life-stage being navigated, wherein:
the player-response data represents player's strategy and wherein the player response data facilitates the at least one player to decide:
an amount from the at least one income to be spent on the appropriate expenses; and
investment of the disposable income in a financial fund; and
a financial information generation module configured to generate a financial information for the at least one player at each life stage of the plurality of life stages based upon the player-response data for providing growth information pertaining to the financial fund.

19. The system of claim 18, wherein the financial information educates the at least one player to understand an impact of the player-response data input by the at least one player in response of the at least one scenario.

20. A computer program product having embodied thereon a computer program for educating at least one player about financial planning through a financial planning game, the computer program product comprising:
a program code for receiving player-associated data input by the at least one player;
a program code for configuring:
plurality of life stages based upon the player-associated data, wherein at least one life stage is associated with the at least one player; and
at least one scenario associated with each life stage, wherein the at least one scenario comprises at least one income and appropriate expenses;
a program code for prompting to the at least one player for investing disposable income at a first life-stage of the plurality of the life stages for proceeding with the financial planning game, wherein the disposable income is an amount left after deducting the appropriate expenses from the at least one income;
a program code for navigating each life stage of the plurality of life stages to the at least one player, wherein the navigating commences after the first life stage;
a program code for presenting the scenario associated with the life stage being navigated in order to capture player-response data for the life stage being navigated, wherein:
the player-response data represents player's strategy and wherein the player response data facilitates the at least one player to decide:
an amount from the at least one income to be spent on the appropriate expenses; and
investment of the disposable income in a financial fund; and
a program code for generating financial information for at least one player at each life stage of the plurality of life stages based upon the player-response data for providing growth information pertaining to the financial fund.
